(19) United States
(12) Patent Application Publication
(10) Pub. No.: US 2021/0286708 A1
(43) Pub. Date: Sep. 16, 2021

(54) METHOD AND ELECTRONIC DEVICE FOR RECOMMENDING CROWDSOURCED TESTER AND CROWDSOURCED TESTING

(71) Applicant: Institute of Software, Chinese Academy of Sciences, Beijing (CN)

(72) Inventors: Qing Wang, Beijing (CN); Junjie Wang, Beijing (CN); Jun Hu, Beijing (CN); Dandan Wang, Beijing (CN)

(73) Assignee: Institute of Software, Chinese Academy of Sciences, Beijing (CN)

(21) Appl. No.: 17/012,254

(22) Filed: Sep. 4, 2020

(30) Foreign Application Priority Data
Mar. 16, 2020 (CN) 202010181691.5

(51) Int. Cl. G06F 11/36; G06F 21/53; G06F 16/335; G06Q 10/06

(52) U.S. Cl. CPC G06F 11/3672; G06F 21/53; G06F 2221/2149; G06Q 10/06311; G06F 16/335

(57) ABSTRACT

The disclosure provides a method and an electronic device for recommending crowdsourced tester and crowdsourced testing. The method comprises: collecting a requirement description of a crowd testing task at a time point in a process of crowd software testing and historical crowd testing reports of each tester to be recommended; obtaining a process context and a resource context of each tester to be recommended; inputting the extracted features into a learning to rank model to obtain an initial ranking list of the recommended testers, and re-ranking the initial ranking list based on diversity contributions of expertise and device to obtain a final ranking list. The disclosure can more accurately recommend testers to take accuracy and diversity of the recommended testers into consideration, so that the testers can be dynamically planned during the crowd testing to improve the bug detection rate, shorten the completion cycle of the crowd testing task.

### CROSS REFERENCE TO RELATED APPLICATION

This application claims the priority of Chinese Patent Application No. 202010181691.5, entitled “method and electronic device for recommending crowdsourced tester and crowdsourced testing” filed with the Chinese Patent Office on Mar. 16, 2020, which is incorporated herein by reference in its entirety.

### TECHNICAL FIELD

The disclosure relates to the field of computer technology, in particular to a method and an electronic device for recommending crowdsourced tester and crowdsourced testing.

### BACKGROUND ART

Crowdsourced software testing (crowd testing for short) refers to that a software company may releases a test task to crowd testing platform on the Internet before a software is officially released, so that crowd testers on the platform will perform the test task and submit crowd testing reports. Crowd testing technology is widely used in the current process of software development or update in a case of relative shortage of professional testers in software companies, due to customer churn and economic losses caused by software errors.

Because most of the crowd testers have no professional software testing background and different abilities, performances of different testers in a crowd testing task are significantly different. Inappropriate crowd testers may miss bugs or repeatedly submit bugs, resulting in a waste of resources. Therefore, it is critical to find an appropriate group of crowd testers for crowd testing tasks in order to reduce repeated bugs, improve a bug detection rate, and better play testers' roles.

In the existing crowd tester recommendation technology, testers are recommended before a start of a new task, without considering continuously changing context information in a process of the crowd testing task, which is not adapted to a process of the dynamically changing crowd testing. For example, Chinese patent application No. CN110096569A discloses a method for recommending a group of crowd testers comprising following steps: according to crowd testing reports of historical crowd testing tasks, generating a technical term base and a five tuple corresponding to each crowd testing report; generating information about experience and field background of each tester based on the crowd testing reports; generating a two tuple of a new crowd testing task corresponding to the pre-processed new crowd testing task; calculating a relevance between a bug detection ability of each tester, an activity of each tester and each tester and the new crowd testing task; generating a group of recommended testers corresponding to the new crowd testing task according to the relevance. This patent is only applicable to the recommendation of testers before the start of the new crowd testing task, and cannot guide and optimize the entire process of crowd testing.

There are usually many long plateaus in the process of a crowd testing, that is, there are no new bugs in multiple consecutive crowd testing reports, based on a survey of actual data of the crowd testing platform. The existence of the plateaus will bring a lot waste of cost, and potentially extend the period of the crowd testing task. By dynamically recommending appropriate crowd testers, the plateau can be shortened so as to speed up the process of the crowd testing and reduce the testing cost.

### SUMMARY

The disclosure intends to provide a method and an electronic device for recommending crowdsourced tester and crowdsourced testing, which may recommend a group of crowd testers for an on-going crowd testing task, improving a bug detection rate and shortening a completion cycle of the crowd testing task.

A method for recommending crowdsourced tester, comprising:

1) collecting a requirement description of a crowd testing task at a time point in a process of a crowdsourced software testing and historical crowd testing reports of each tester to be recommended, and obtaining a set of descriptive term vectors for each tester to be recommended;

2) obtaining a process context of each tester to be recommended by calculating a test adequacy, and obtaining a resource context of each tester to be recommended according to a personnel characteristic of each tester to be recommended;

3) inputting features obtained from the process context and the resource context of each tester to be recommended into a learning to rank model, obtaining an initial ranking list of the recommended testers, and re-ranking the initial ranking list of the recommended testers based on diversity contributions of an expertise and a device of the tester to be recommended, to obtain a final ranking list of the recommended testers.

Optionally, the step of obtaining the set of descriptive term vectors comprises:

1) performing word segmentation, removal of stop words, and synonym replacement on the requirement description of the crowd testing task and the historical crowd testing reports, to obtain a first set of term vectors;

2) calculating a frequency of any vector in the first set of term vector appearing in the requirement description of the crowd testing task and the crowd testing reports, and obtaining a descriptive term base based on a set value;

3) filtering the requirement description of the crowd testing task and the historical crowd testing reports based on the descriptive term base, to obtain the set of descriptive term vectors.

Optionally, the test adequacy is obtained according to the number of bug reports containing the descriptive terms and the number of submitted bug reports.

Optionally, the personnel characteristic comprises activity, preference, expertise and device of the tester to be recommended.

Optionally, the activity comprises time intervals between a time when the latest bug is found and a time when the latest report is submitted and the time point respectively, and numbers of bugs to be found and reports to be submitted within a set time; the preference is obtained by a probability representation of the set of descriptive term vectors of the reports submitted by the recommended testers in the past; the expertise is obtained by a probability representation of the set of descriptive term vectors of the bugs found by the recommended testers in the past; the device includes a phone model, an operating system, a ROM type, and a network environment.

Optionally, the feature includes time intervals between a time when the latest bug is found and a time when the latest report is submitted and the time point respectively, numbers of bugs to be found and reports to be submitted within the set time, Cosine similarity, Euclidean similarity and Jaccard similarity between the preference of the tester to be recommended and the test adequacy, and Cosine similarity, Euclidean similarity and Jaccard similarity between the expertise of the tester to be recommended and the test adequacy.

Optionally, the step of obtaining the learning to rank model comprises:

1) for each task that has been closed on the crowd testing platform, randomly selecting a sampling time point of a progress of each task in collecting a requirement description of each crowd testing task that has been closed and historical crowd testing reports of all relevant testers, and obtaining the set of descriptive term vectors of each relevant tester;

2) obtaining a first sample process context of each relevant tester by calculating the test adequacy of each relevant tester, and obtaining a first sample resource context of each tester to be recommended according to the personnel characteristics of each relevant tester;

3) obtaining a second sample process context and a second sample resource context according to bugs found by the relevant tester after the sampling time point;

4) extracting a sample feature of the second sample process context and a sample feature of the second sample resource context respectively, and establishing the learning to rank model according to a learning to rank algorithm.

Optionally, the step of re-ranking the initial ranking list of the recommended testers based on the diversity contribution of the expertise and the device comprises:

1) moving the first tester in the initial ranking list of the recommended testers to the final ranking list of the recommended testers, and deleting the first tester from the initial ranking list of the recommended testers at the same time;

2) calculating a diversity contribution of the expertise and diversity contribution of the device of each remaining initial recommended tester in the initial ranking list of the recommended testers respectively, and ranking the remaining initial recommended testers in descending order by the diversity contribution of expertise and the diversity contribution of the device respectively;

3) calculating a combined diversity of each remaining initial recommended tester, and moving the tester with a smallest combined diversity into the final ranking list of the recommended testers; and

4) obtaining the final ranking list of the recommended testers by repeating steps 2)-3).

A method for crowdsourced testing, performing crowdsourced testing by using several top recommended testers in the final ranking list of the recommended testers obtained according to the above methods.

A electronic device, comprising a memory storing a computer program and a processor, wherein, the processor is configured to run the computer program to perform the above methods.

Compared with the prior art, models of the process context and the resource context can be established during the crowd testing in the disclosure to more accurately recommend testers based on the current context information. Both accuracy and diversity of the recommended testers can be taken into consideration to dynamically plan the testers during the crowd testing, to improve the defect detection rate, shorten the completion cycle of the crowd testing task, and facilitate a more efficient crowd testing service mode.

The disclosure can dynamically recommend a group of diversified and capable testers based on the current context information at a certain time point in the process of crowd testing. According to the present disclosure, information in the crowd testing process is captured by establishing the model of the process context and the resource context, recommendation of testers is carried out through the learning to rank technology and the re-ranking technology based on a diversity, to reduce repeated bugs, improve the bug detection rate, and shorten the completion cycle of the crowd testing task.

### BRIEF DESCRIPTION OF THE DRAWINGS

FIG. 1 is a frame diagram of a method for recommending a group of testers in a process of crowd testing.

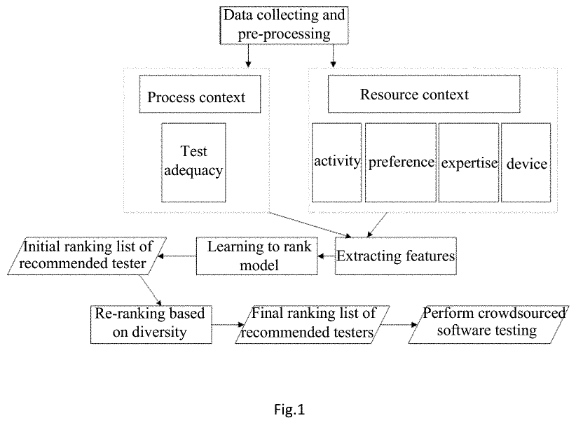

FIG. 2 shows the performance comparison among the present method and other existing methods.

### DETAILED DESCRIPTION OF THE EMBODIMENTS

In the following, the method is further described in combination with specific embodiments;

The technical solution of the disclosure comprises: collecting and pre-processing various information in a process of crowd testing task; establishing a model of a process context of the task in a view of test adequacy; establishing a model of a resource context of the task in four aspects of activity, preference, expertise and device for each crowd tester; based on this, extracting features to establish a learning to rank model for predicting a probability of the tester finding bugs in the current context, to obtain an initial ranking list of the recommended testers; and re-ranking the initial ranking list of the recommended testers based on a diversity to obtain a final ranking list of the recommended testers. The method of the present disclosure is shown in the figure, and specifically comprises following steps:

1) collecting and pre-processing various information in the process of the crowd testing task, including the following sub-steps:

1a) collecting relevant information for a certain time point in the process of the crowd testing, including: a requirement description of the current crowd testing task, crowd testing reports submitted for the current crowd testing task, and crowd testers registered on the platform (as well as crowd testing reports submitted by each crowd tester in the past);

1b) performing natural language processing on all of the crowd testing reports (reports submitted for the task and reports submitted by testers in the past) and the requirement description of the task, which are respectively represented as descriptive term vectors of each crowd testing report and each task requirement, including the following sub-steps:

Each of the crowd testing reports and the requirement description of crowd testing task is called as a document;

1b-1) performing word segmentation, removal of stop words, and synonym replacement on each document, and representing each document as a term vector;

1b-2) for all documents, calculating a document frequency of each term (the number of crowd testing reports in which the term appears), filtering out terms with the top m % (e.g. 5%) of the document frequency and those with the last n % (e.g. 5%) of the document frequency, such that remaining terms form a descriptive term base. Wherein, the reason that terms with the top 5% of the document frequency are filtered out lies in that these terms appear in many documents and have no good discrimination; and the reason that terms with the last 5% of the document frequency are filtered out also lies in that these terms can hardly have discriminative information;

1b-3) filtering the term vectors of each document based on the descriptive term base, filtering out the words that do not appear in the descriptive term base, and obtaining the descriptive term vectors of each document.

2) establishing a model of the process context of the crowd testing task in view of a test adequacy, including the following sub-steps:

2a) calculating the test adequacy TestAdeq, which indicates a degree to which the requirement of a crowd testing task is tested, wherein TestAdeq is formalized as

$$TestAdeq ( {t}_{j} ) = \frac{Number of defect reports with {t}_{j}}{Number of defect reports submitted in the task} ,$$

wherein tⱼ represents the j^{th} term in the descriptive term vector of the requirement of the crowd testing task; the larger TestAdeq(tⱼ), the more adequately an aspect of the task related with the descriptive term tⱼ is tested. This definition supports fine-grained matching of the preferences or expertise of a crowd tester to aspects that have not been adequately tested.

3) establishing a model of the resource context of the crowd testing task in four aspects of crowd tester's activity, preference, expertise and device, including the following sub-steps:

3a) using the following four attributes to describe the activity of the crowd tester: LastBug (time interval in hours between the current time and the time when the latest defect is found by the crowd tester), LastReport (time interval in hours between the current time and the time when the latest report is submitted by the crowd tester), NumBugs-X (the total number of bugs found by the crowd tester during the past X time, wherein, X is a time parameter, which can be set to any time period, such as the past 2 weeks), and NumReports-X (the total number of reports submitted by the crowd tester during the past X time);

3b) using ProbPref to describe the preferences of the crowd tester, which indicates the preference of the crowd tester for each descriptive term, that is, a probability of recommending a crowd tester to generate a report with a descriptive term tⱼ; wherein ProbPref is formalized as

$$ProbPref ( w , {t}_{j} ) = P ( w \vert {t}_{j} ) = \frac{tf\_p ( w , {t}_{j} )}{{\sum }_{{w}_{k}} tf\_p ( {w}_{k} , {t}_{j} )} \cdot \frac{{\sum }_{{w}_{k}} {df}_{p ( {w}_{k} )}}{df ( w )} ,$$

wherein w is any one of crowd testers, wₖ represents the traversal of all of the crowd testers, tf_p(w,tⱼ) is the number of occurrences of the descriptive term tⱼ in reports submitted by the crowd tester w in the past, which can be obtained based on the descriptive term vector of the reports submitted by the crowd tester in the past; df_p(w) is the total number of crowd testing reports submitted by the crowd tester w;

using ProbExp to describe the expertise of the crowd tester, which indicates the expertise of a crowd tester for each descriptive term; ProbExpis is formalized as

$$ProbExp ( w , {t}_{j} ) = P ( w \vert {t}_{j} ) = \frac{tf\_e ( w , {t}_{j} )}{{\sum }_{{w}_{k}} tf\_e ( {w}_{k} , {t}_{j} )} \cdot \frac{{\sum }_{{w}_{k}} df\_e ( {w}_{k} )}{df ( w )} ,$$

wherein w is any one of crowd testers, wₖ represents the traversal of all of the crowd testers, tf_e(w,tⱼ) is the number of occurrences of the descriptive term tⱼ in bugs found by the crowd tester w in the past, which can be obtained based on the descriptive term vector of the reports with bugs submitted by the tester in the past; df_e(w) is the total number of bugs found by the crowd tester w. The difference between ProbPref and ProfExp lies in that: the former is based on the reports submitted by the crowd tester, while the latter is based on the bugs found by the crowd tester. The reason for describing preference and expertise of the tester according each descriptive term is that it can better match exactly the terms that have not been adequately tested, and conduct a fine-grained recommendation of more diversified crowd testers to find more new bugs;

3d) using the following four attributes to describe the device of the crowd testers: a model (a model of a mobile phone running tasks), an operating system (a model of an operating system of the mobile phone running the task), a ROM type (a ROM type of the mobile phone) and a network environment (the network environment in which the task runs).

4) Extracting features based on historical data, and establishing and training a learning to rank model; extracting and inputting features, based on new project data, to a trained learning to rank model to predict the probability that the tester finds bugs in the current context, and obtaining an initial ranking list of the recommended testers, comprising the following sub-steps:

4a) extracting features based on historical data, and establishing and training a learning to rank model about a probability that the tester finds bugs, comprising the following sub-steps:

4a-1) preparing training data, randomly selecting a time point when a task is in progress for each closed task on the crowd testing platform, and sequentially performing the operations of step 1, step 2, step 3 and step 4a to obtain a process context and a resource context; if a crowd tester finds a bug after the current time point of the task, denoting the dependent variable of the group of features as 1, otherwise denoting the dependent variable as 0;

4a-2) extracting the features in table 1 for each crowd tester based on the obtained process context and resource context:

TABLE 1

| Type | Number | Feature description |
|---|---|---|
| Tester's | 1 | LastBug |
| Activity | 2 | LastReport |
| | 3-7 | NumBugs-8 hours, NumBugs-24 hours, |
| | | NumBugs-1 week, NumBugs-2 week, |
| | | NumBug-all (“all” means all |
| | | the past time) |
| | 8-12 | NumReports-8 hours, NumReports-24 |
| | | hours, NumReports-1 week, NumReports- |
| | | 2 week, NumReports-all(“all” means |
| | | all the past time) |
| Tester's | 13-14 | Cosine similarity and Euclidean similarity |
| Preference | | between preference of the tester and the |
| | | test adequacy |
| | 15-19 | Jaccard similarity between preference of |
| | | the tester and the test adequacy, wherein |
| | | thresholds of 0.0, 0.1, 0.2, 0.3 and 0.4 |
| | | were used respectively |
| Test's | 20-21 | Cosine similarity and Euclidean similarity |
| Expertise | | between expertise of the tester and the |
| | | test adequacy |
| | 22-26 | Jaccard similarity between expertise of |
| | | the tester and the test adequacy, wherein |
| | | thresholds of 0.0, 0.1, 0.2, 0.3 and 0.4 |
| | | were used respectively |

Wherein the features of numbers 1 to 12 can be directly obtained through the activity attribute of the tester in the step 3; given tᵢ as any descriptive term for the requirement of the crowd testing task, 1.0-TestAdeq(tᵢ) (denoted as xᵢ) indicates the degree of inadequency of testing the descriptive technical term tⱼ in the crowd testing task, ProbPref(w,tᵢ) (denoted as yᵢ) indicates the preference of the tester w for the descriptive term tⱼ, the Cosine similarity of feature 13 is calculated by

$$\frac{\sum {x}_{i} * {y}_{i}}{\sqrt{\sum {x}_{i}^{2}} \sqrt{\sum {x}_{i}^{2}}} ,$$

the Euclidean similarity of feature 14 is calculated by \sqrt{Σ(xᵢ−yᵢ)²}, the Jaccard similarity of features 15-19 is calculated by

$$\frac{A ⋂ B}{A U B} ,$$

wherein A is a set of descriptive terms with xᵢ greater than a given threshold, B is a set of descriptive terms with yᵢ greater than a given threshold, the threshold values are set to 0.0, 0.1, 0.2, 0.3, 0.4 respectively; and yᵢ is represented as ProbExp(w,tᵢ), and features 20-26 may be obtained in the same manner;

4a-3) establishing and training the learning to rank model about the probability that the tester finds bugs by using a learning to rank algorithm (i.e. LambdaMART) based on the extracted features;

4b) predicting the probability that each crowd tester finds bugs at a certain time point in the process of the new project based on the trained model, and ranking the crowd testers according to the sequence of the probability from largest to smallest to obtain the initial ranking list of the recommended testers, comprising the following sub-steps:

4b-1) sequentially performing operations of step 1, step 2, step 3 and step 4a for the certain time point in the process of the new project, to obtain the process context and the resource context;

4b-2) extracting the features of each crowd tester by using the operation of 4a-2);

4b-3) inputting the features into the model trained in step 4a-3) to obtain the probability that each crowd tester finds bugs.

5) re-ranking the initial ranking list of the recommended testers based on a diversity to obtain a final ranking list of the recommended testers, comprising the following sub-steps:

given that there are ranked testers from w₁ to wₙ in the initial ranking list W of the recommended testers, and a final ranking list of the recommended testers is denoted as S;

5a) moving w₁ who is the most likely to find a bug into the final ranking list S of testers and deleting w₁ from W at the same time;

calculating the diversity contribution of expertise of each crowd tester in W, ExpDiv(w,S)=Σₜ_{ⱼ}ProfExp(w,tⱼ)×Π_{w}_{ₖ}_{∈s}(1.0−ProfExp(wₖ,tⱼ), wherein tⱼ is any descriptive term for the requirement of the crowd testing task, w is a certain crowd tester in the initial ranking list of the recommended testers, wₖ is any crowd tester in the final ranking list of the recommended testers; the second half of the formula is an estimated degree of testing the descriptive technical term tⱼ by a tester in the current final ranking list of the recommended testers; if a certain crowd tester has different expertise from the tester in the current final ranking list of the recommended testers, the crowd tester has a greater contribution to the diversity of expertise;

5c) calculating the diversity contribution of the device of each crowd tester in W, DevDiv(w,S)=w′s attributes−∪_{w}_{ₖ}_{∈S} (w′ₖs attributes), wherein w′s attributes and wₖ′s attributes indicate sets of attribute values of the devices of crowd testers in the initial ranking list of the recommended testers and the final ranking list of the recommended testers, respectively; if a certain crowd tester has a different device from the tester in the current final ranking list of the recommended testers, the crowd tester has a greater contribution to the diversity of device;

5d) ranking the testers in W in descending order, based on the diversity contribution of the expertise and the diversity contribution of the device, to obtain ranking positions of each crowd tester in corresponding ranking lists, which are denoted as expI(w) and devI(w), respectively;

5e) calculating a combined diversity of each tester, expI(w)+divRatio*devI(w), wherein divRatio is a set weight indicating a relative weight of an expertise diversity and a device diversity for an overall ranking; and moving a tester with the smallest combined diversity into S;

5f) repeating steps 5b-5e until W is empty, and S is the final ranking list of the recommended testers.

6) recommending the top i crowd testers to the project based on the final ranking list of the recommended testers (i is an input parameter which can be set according to the number of testers required by the project), to perform crowd software testing by these testers.

The present disclosure is described below through a practical application.

Step 1, collecting and pre-processing various information in the process of crowd testing task. The information is collected for a certain time point in a process of the crowd testing, i.e. the time point of the tester to be recommended. The reason that reports submitted by each tester in the past need to be collected lies in modeling the resource context, and the more the information of the historical activities of the tester is, the more accurate the obtained model is. After each crowd testing task is started, many crowd testing reports submitted by crowd testers are received, and 4 attributes of the crowd testing reports need to be collected: a report submitter, submission time, a bug or not, a natural language description of the report. The “submitter” represents a crowd tester who submits the crowd testing report and is typically represented by a person identifier (id). The attribute is used for corresponding the past activities to a corresponding crowd tester so as to perform tester modeling. The “submission time” represents the time at which the crowd testing report was submitted, and the attribute is used to describe the activity of the tester. The bugs in the crowd testing report are really concerned by the test. “A bug or not” represents whether the crowd testing report describes a bug, and this attribute is an important feature for describing the experience of the tester, and is also a dependent variable for establishing a machine learning model to predict the bug detection ability of the tester. The “natural language description of the report” represents the description of the content of the crowd testing report, such as operation steps and problem description, and this attribute is mainly used for describing the field background of the tester.

Step 2, establishing a model of the process context of the crowd testing task in the view of test adequacy.

Step 3, establishing a model of the resource context of the crowd testing task in four aspects of crowd tester's activity, preference, expertise and device.

Step 4, extracting features to establish a learning to rank model based on the process context and the resource context for predicting the probability that the tester finds bugs in the current context, and achieving the initial ranking list of the recommended testers. Among the features used for learning to rank, NumBugs-X and NumReports-X only select 8 hours, 24 hours, 1 week, 2 weeks and all, which are more representative, and others can also be added. Only a few people participated in and found the bugs for a crowd testing task during establishing and training a learning to rank model about probability that the tester finds bugs, so data item with dependent variable 1 is much less than data item with dependent variable 0, and in this case, the data balancing can be performed by using an under sampling algorithm, so that the model can play a better role.

Step 5, re-ranking the initial ranking list of the recommended testers based on the diversity to obtain a final ranking list of the recommended testers. By experimenting with multiple values on a verification set, the divRatio can be determined according to a recommendation effect of testers under different values.

The experimental results are given below to illustrate a performance of this method in improving the bug detection rate and shortening the completion cycle of the crowd testing task.

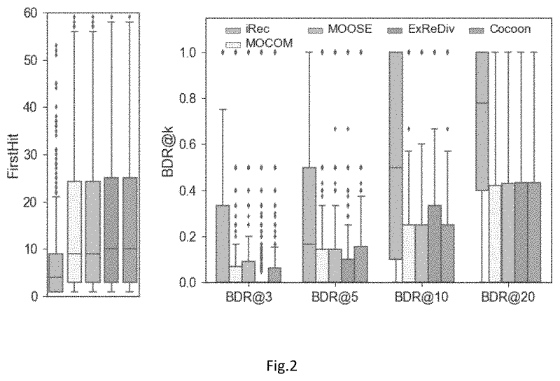

Referring to FIG. 2 and table 2, iRec represents the present disclosure. The disclosure is based on 636 mobile application crowd testing tasks carried out by a crowd testing platform from May 1, 2017 to Nov. 1, 2017, involving 2404 crowd testers and 80200 crowd testing reports. The first 500 items are used as training set, and the performance of the method is evaluated on the last 136 items.

Evaluation indicators include BDR@k and FirstHit. BDR@k indicates the bug detection rate, i.e. the percentage of bugs found by the top k recommended crowd testers to the total bugs, and k is taken as 3, 5, 10 and 20 for analysis. FirstHit indicates a ranking of the first tester who found a bug on the recommendation list, i.e. the situation of shortening the task completion cycle.

The advantages of this method are better illustrated by comparing the four existing methods. MOCOM (Chinese patent application No. CN110096569A) is a multi-objective optimization method for recommending testers, which can find the most capable, most relevant, most diverse and least cost testers. ExReDiv (Q. Cui, J. Wang, G. Yang, M. Xie, Q. Wang, and M. Li, “Who should be selected to perform a task in crowdsourced testing”) is a weight-based method for recommending testers, which can linearly combine a capability of a tester, a task relevance and a diversity. MOOSE (Q. Cui, S. Wang, J. Wang, Y. Hu, Q. Wang, and M. Li, “Multi-objective crowd worker selection in crowdsourced testing” in SEKE′17, 2017, pp. 218-223) is a multi-objective optimization method for recommending testers, which can maximize a coverage of testing requirements, maximize personnel testing capabilities, and minimize costs. Cocoon (M. Xie, Q. Wang, G. Yang, and M. Li, “Cocoon: Crowdsourced testing quality maximization under context coverage constraint” in ISSRE′17, 2017, pp. 316-327) is a method to maximize a test quality under the constraints of a test coverage, which can maximize test quality under the constraints of the test coverage.

The performance comparison of BDR@k and FirstHit between the present disclosure (iRec for short) and other baseline methods is given respectively.

TABLE 2

| | FirstHit | | | | | BDR @ 3 | | | | |
|---|---|---|---|---|---|---|---|---|---|---|
| | Minimum | First | Median | Third | Maximum | Minimum | First | Median | Third | Maximum |
| | value | quartile | value | quartile | value | value | quartile | value | quartile | value |
| iRec | 1 | 1 | 4 | 9 | 52 | 0.0 | 0.0 | 0.0 | 0.38 | 1.0 |
| MOCOM | 1 | 3 | 9 | 24 | 69 | 0.0 | 0.0 | 0.0 | 0.08 | 1.0 |
| ExReDiv | 1 | 3 | 9 | 24 | 69 | 0.0 | 0.0 | 0.0 | 0.10 | 1.0 |
| Moose | 1 | 3 | 10 | 26 | 75 | 0.0 | 0.0 | 0.0 | 0.0 | 1.0 |
| Cocoon | 1 | 3 | 10 | 26 | 79 | 0.0 | 0.0 | 0.0 | 0.07 | 1.0 |
| | BDR @ 5 | | | | | BDR @ 10 | | | | |
| | Minimum | First | Median | Third | Maximum | Minimum | First | Median | Third | Maximum |
| | value | quantile | value | quartile | value | value | quantile | value | quartile | value |
| iRec | 0.0 | 0.0 | 0.18 | 0.5 | 1.0 | 0.0 | 0.10 | 0.5 | 1.0 | 1.0 |
| MOCOM | 0.0 | 0.0 | 0.0 | 0.15 | 1.0 | 0.0 | 0.0 | 0.0 | 0.28 | 1.0 |
| ExReDiv | 0.0 | 0.0 | 0.0 | 0.15 | 1.0 | 0.0 | 0.0 | 0.0 | 0.28 | 1.0 |
| Moose | 0.0 | 0.0 | 0.0 | 0.13 | 1.0 | 0.0 | 0.0 | 0.0 | 0.32 | 1.0 |
| Cocoon | 0.0 | 0.0 | 0.0 | 0.17 | 1.0 | 0.0 | 0.0 | 0.0 | 0.28 | 1.0 |

Obviously, the method of the disclosure is significantly superior to other baseline methods. Average BDR@10 of this method is about 50%, which means that 50% bugs on average can be found by the top 10 testers recommended based on this method, while the average BDR@10 of the baseline method is about 0%. This shows that the bug detection rate can be improved according to the method of the present disclosure. The average FirstHit of the present disclosure is 4, while that of the baseline method is 9-10, that is, the fourth tester among recommended testers of the present method can find the first bug, while 9-10 testers are needed to find the first bug in the baseline method, which means that the method of the present disclosure can shorten the completion cycle of the task.

Although the specific content, implementation algorithm and drawings of the present disclosure are disclosed for illustrative purposes, the purpose is to help understand the content of the present disclosure and implement it accordingly, but those skilled in the art would understand that: without departing from the spirit and scope of the present disclosure and the appended claims, various substitutions, changes, and modifications are possible. The present disclosure should not be limited to the contents disclosed in the preferred embodiments of the present specification and the accompanying drawings. And the claimed scope of the disclosure shall be subject to the scope defined in the claims.

1. A method for recommending crowdsourced tester, comprising:
1) collecting a requirement description of a crowd testing task at a time point in a process of a crowdsourced software testing and historical crowd testing reports of each tester to be recommended, and obtaining a set of descriptive term vectors for each tester to be recommended;
2) obtaining a process context of each tester to be recommended by calculating a test adequacy, and obtaining a resource context of each tester to be recommended according to a personnel characteristic of each tester to be recommended; and
3) inputting features obtained from the process context and the resource context of each tester to be recommended into a learning to rank model, obtaining an initial ranking list of recommended testers, and re-ranking the initial ranking list of the recommended testers based on diversity contributions of an expertise and a device of the tester to be recommended, to obtain a final ranking list of the recommended testers.

2. The method according to claim 1, the step of obtaining the set of descriptive term vectors comprises:
1) performing word segmentation, removal of stop words, and synonym replacement on the requirement description of the crowd testing task and the historical crowd testing reports, to obtain a first set of term vectors;
2) calculating a frequency of any vector in the first set of term vectors appearing in the requirement description of the crowd testing task and the crowd testing reports, and obtaining a descriptive term base based on a set value;
3) filtering the requirement description of the crowd testing task and the historical crowd testing reports based on the descriptive term base, to obtain the set of descriptive term vectors.

3. The method according to claim 1, wherein, the test adequacy is obtained according to a number of bug reports containing the descriptive terms and a number of submitted bug reports.

4. The method according to claim 1, wherein, the personnel characteristic comprises activity, preference, expertise and device of the tester to be recommended.

5. The method according to claim 4, wherein, the activity comprises time intervals between a time when the latest bug is found and a time when the latest report is submitted and the time point respectively, and numbers of bugs to be found and reports to be submitted within a set time; the preference is obtained by a probability representation of the set of descriptive term vectors of the reports submitted by the recommended testers in the past; the expertise is obtained by a probability representation of the set of descriptive term vectors of the bugs found by the recommended testers in the past; the device comprises a phone model, an operating system, a ROM type, and a network environment.

6. The method according to claim 1, wherein, the features include time intervals between a time when the latest bug is found and a time when the latest report is submitted and the time point respectively, numbers of bugs to be found and reports to be submitted within the set time, Cosine similarity, Euclidean similarity and Jaccard similarity between the preference of the tester to be recommended and the test adequacy, and Cosine similarity, Euclidean similarity and Jaccard similarity between the expertise of the tester to be recommended and the test adequacy.

7. The method according to claim 1, wherein, the step of obtaining the learning to rank model comprises:
1) for each task that has been closed on the crowd testing platform, randomly selecting a sampling time point of the process of each task, collecting a requirement description of each crowd testing task that has been closed and historical crowd testing reports of all relevant testers, and obtaining the set of descriptive term vectors of each relevant tester;
2) obtaining a first sample process context of each relevant tester by calculating the test adequacy of each relevant tester, and obtaining a first sample resource context of each tester to be recommended according to the personnel characteristics of each relevant tester;
3) obtaining a second sample process context and a second sample resource context according to bugs found by the relevant tester after the sampling time point;
4) extracting a sample feature of the second sample process context and a sample feature of the second sample resource context respectively, and establishing the learning to rank model according to a learning to rank algorithm.

8. The method according to claim 1, wherein, the step of re-ranking the initial ranking list of the recommended testers based on the diversity contribution of the expertise and the device comprises:
1) moving the first tester in the initial ranking list of the recommended testers to the final ranking list of the recommended testers, and deleting the first tester from the initial ranking list of the recommended testers at the same time;
2) calculating a diversity contribution of the expertise and a diversity contribution of the device of each remaining initial recommended tester in the initial ranking list of the recommended testers respectively, and ranking the remaining initial recommended testers in descending order by the diversity contribution of the expertise and the diversity contribution of the device respectively;
3) calculating a combined diversity of each remaining initial recommended tester, and moving the tester with a smallest combined diversity into the final ranking list of the recommended testers; and
4) obtaining the final ranking list of the recommended testers by repeating steps 2)-3).

9. A method for crowdsourced testing, performing crowdsourced testing by using several top recommended testers in a final ranking list of the recommended testers obtained by a method for recommending crowdsourced tester, which comprises:
1) collecting a requirement description of a crowd testing task at a time point in a process of a crowdsourced software testing and historical crowd testing reports of each tester to be recommended, and obtaining a set of descriptive term vectors for each tester to be recommended;
2) obtaining a process context of each tester to be recommended by calculating a test adequacy, and obtaining a resource context of each tester to be recommended according to a personnel characteristic of each tester to be recommended; and
3) inputting features obtained from the process context and the resource context of each tester to be recommended into a learning to rank model, obtaining an initial ranking list of recommended testers, and re-ranking the initial ranking list of the recommended testers based on diversity contributions of an expertise and a device of the tester to be recommended, to obtain a final ranking list of the recommended testers.

10. (canceled)

11. The method according to claim 9, the step of obtaining the set of descriptive term vectors comprises:
1) performing word segmentation, removal of stop words, and synonym replacement on the requirement description of the crowd testing task and the historical crowd testing reports, to obtain a first set of term vectors;
2) calculating a frequency of any vector in the first set of term vectors appearing in the requirement description of the crowd testing task and the crowd testing reports, and obtaining a descriptive term base based on a set value;
3) filtering the requirement description of the crowd testing task and the historical crowd testing reports based on the descriptive term base, to obtain the set of descriptive term vectors.

12. The method according to claim 9, wherein, the test adequacy is obtained according to a number of bug reports containing the descriptive terms and a number of submitted bug reports.

13. The method according to claim 9, wherein, the features include time intervals between a time when the latest bug is found and a time when the latest report is submitted and the time point respectively, numbers of bugs to be found and reports to be submitted within the set time, Cosine similarity, Euclidean similarity and Jaccard similarity between the preference of the tester to be recommended and the test adequacy, and Cosine similarity, Euclidean similarity and Jaccard similarity between the expertise of the tester to be recommended and the test adequacy.

14. The method according to claim 9, wherein, the step of obtaining the learning to rank model comprises:
1) for each task that has been closed on the crowd testing platform, randomly selecting a sampling time point of the process of each task, collecting a requirement description of each crowd testing task that has been closed and historical crowd testing reports of all relevant testers, and obtaining the set of descriptive term vectors of each relevant tester;
2) obtaining a first sample process context of each relevant tester by calculating the test adequacy of each relevant tester, and obtaining a first sample resource context of each tester to be recommended according to the personnel characteristics of each relevant tester;
3) obtaining a second sample process context and a second sample resource context according to bugs found by the relevant tester after the sampling time point;
4) extracting a sample feature of the second sample process context and a sample feature of the second sample resource context respectively, and establishing the learning to rank model according to a learning to rank algorithm.

15. The method according to claim 9, wherein, the step of re-ranking the initial ranking list of the recommended testers based on the diversity contribution of the expertise and the device comprises:
1) moving the first tester in the initial ranking list of the recommended testers to the final ranking list of the recommended testers, and deleting the first tester from the initial ranking list of the recommended testers at the same time;
2) calculating a diversity contribution of the expertise and a diversity contribution of the device of each remaining initial recommended tester in the initial ranking list of the recommended testers respectively, and ranking the remaining initial recommended testers in descending order by the diversity contribution of the expertise and the diversity contribution of the device respectively;
3) calculating a combined diversity of each remaining initial recommended tester, and moving the tester with a smallest combined diversity into the final ranking list of the recommended testers; and
4) obtaining the final ranking list of the recommended testers by repeating steps 2)-3).

16. An electronic device, comprising a memory storing a computer program and a processor, wherein, the processor is configured to run the computer program to perform a method for recommending crowdsourced tester, which comprises:
1) collecting a requirement description of a crowd testing task at a time point in a process of a crowdsourced software testing and historical crowd testing reports of each tester to be recommended, and obtaining a set of descriptive term vectors for each tester to be recommended;
2) obtaining a process context of each tester to be recommended by calculating a test adequacy, and obtaining a resource context of each tester to be recommended according to a personnel characteristic of each tester to be recommended; and
3) inputting features obtained from the process context and the resource context of each tester to be recommended into a learning to rank model, obtaining an initial ranking list of recommended testers, and re-ranking the initial ranking list of the recommended testers based on diversity contributions of an expertise and a device of the tester to be recommended, to obtain a final ranking list of the recommended testers.

17. The electronic device according to claim 16, the step of obtaining the set of descriptive term vectors comprises:
1) performing word segmentation, removal of stop words, and synonym replacement on the requirement description of the crowd testing task and the historical crowd testing reports, to obtain a first set of term vectors;
2) calculating a frequency of any vector in the first set of term vectors appearing in the requirement description of the crowd testing task and the crowd testing reports, and obtaining a descriptive term base based on a set value;
3) filtering the requirement description of the crowd testing task and the historical crowd testing reports based on the descriptive term base, to obtain the set of descriptive term vectors.

18. The electronic device according to claim 16, wherein, the test adequacy is obtained according to a number of bug reports containing the descriptive terms and a number of submitted bug reports.

19. The electronic device according to claim 16, wherein, the features include time intervals between a time when the latest bug is found and a time when the latest report is submitted and the time point respectively, numbers of bugs to be found and reports to be submitted within the set time, Cosine similarity, Euclidean similarity and Jaccard similarity between the preference of the tester to be recommended and the test adequacy, and Cosine similarity, Euclidean similarity and Jaccard similarity between the expertise of the tester to be recommended and the test adequacy.

20. The electronic device according to claim 16, wherein, the step of obtaining the learning to rank model comprises:
1) for each task that has been closed on the crowd testing platform, randomly selecting a sampling time point of the process of each task, collecting a requirement description of each crowd testing task that has been closed and historical crowd testing reports of all relevant testers, and obtaining the set of descriptive term vectors of each relevant tester;
2) obtaining a first sample process context of each relevant tester by calculating the test adequacy of each relevant tester, and obtaining a first sample resource context of each tester to be recommended according to the personnel characteristics of each relevant tester;
3) obtaining a second sample process context and a second sample resource context according to bugs found by the relevant tester after the sampling time point;
4) extracting a sample feature of the second sample process context and a sample feature of the second sample resource context respectively, and establishing the learning to rank model according to a learning to rank algorithm.

21. The electronic device according to claim 16, wherein, the step of re-ranking the initial ranking list of the recommended testers based on the diversity contribution of the expertise and the device comprises:
1) moving the first tester in the initial ranking list of the recommended testers to the final ranking list of the recommended testers, and deleting the first tester from the initial ranking list of the recommended testers at the same time;
2) calculating a diversity contribution of the expertise and a diversity contribution of the device of each remaining initial recommended tester in the initial ranking list of the recommended testers respectively, and ranking the remaining initial recommended testers in descending order by the diversity contribution of the expertise and the diversity contribution of the device respectively;
3) calculating a combined diversity of each remaining initial recommended tester, and moving the tester with a smallest combined diversity into the final ranking list of the recommended testers; and
4) obtaining the final ranking list of the recommended testers by repeating steps 2)-3).
